(19) United States
(12) Patent Application Publication
(10) Pub. No.: US 2015/0188224 A1
(43) Pub. Date: Jul. 2, 2015

(54) MOBILE COMMUNICATION DEVICE

(71) Applicant: Acer Incorporated, New Taipei City (TW)

(72) Inventor: Chih-Hua Chang, New Taipei City (TW)

(73) Assignee: Acer Incorporated, New Taipei City (TW)

(21) Appl. No.: 14/253,877

(22) Filed: Apr. 16, 2014

(30) Foreign Application Priority Data
Dec. 26, 2013 (TW) 102148492

(51) Int. Cl. H01Q 5/00

(52) U.S. Cl. CPC H01Q 5/0055

(57) ABSTRACT

A mobile communication device is provided and includes an antenna element and a switching element. The antenna element converts a radio-frequency signal into an electromagnetic wave and includes an excitation portion and a shorting portion. The excitation portion receives the radio-frequency signal and a direct-current signal. The shorting portion is electrically connected to a ground element. The shorting portion and the excitation portion are spaced by a coupling gap. The switching element is electrically connected between the excitation portion and the shorting portion, and switches the structure of the antenna element according to the direct-current signal.

### CROSS-REFERENCE TO RELATED APPLICATION

This application claims the priority benefit of Taiwan application serial no. 102148492, filed on Dec. 26, 2013. The entirety of the above-mentioned patent application is hereby incorporated by reference herein and made a part of this specification.

### BACKGROUND OF THE INVENTION

1. Field of the Invention

The invention relates to a mobile communication device, and particularly, to a mobile communication device capable of switching the structure of an antenna element.

2. Description of Related Art

With the rapid development of wireless communication technology, various mobile communication devices are constantly introduced. Moreover, a multifunctional mobile communication device such as a smart phone, a tablet computer, and a notebook computer makes life more convenient. With the trend toward the miniaturization of the mobile communication device, the available space of the antenna element in the mobile communication device becomes more limited as a result.

However, when the available space of the antenna element is insufficient, the bandwidth of the antenna element is directly affected. As a result, the antenna element cannot cover the frequency band needed to be supported. Therefore, how to design an antenna element having multi-band operation in the limited space of a mobile communication device has become a major issue in the design of the antenna element.

### SUMMARY OF THE INVENTION

The invention provides a mobile communication device. The mobile communication device switches the structure of an antenna element by using a switching element and transmits a direct-current signal for controlling the switching element through an excitation portion in the antenna element. Therefore, the antenna element can achieve multi-band operation so as to facilitate the miniaturization of the mobile communication device.

The mobile communication device of the invention includes an antenna element and a switching element. The antenna element converts a radio-frequency signal into an electromagnetic wave and includes an excitation portion and a shorting portion. The excitation portion receives the radio-frequency signal and a direct-current signal. The shorting portion is electrically connected to a ground element. The shorting portion and the excitation portion are spaced by a coupling gap. The switching element is electrically connected between the excitation portion and the shorting portion, and switches the structure of the antenna element according to the direct-current signal.

Based on the above, in the invention, a switching element is disposed between an excitation portion and a shorting portion of an antenna element, and the switching element is configured to switch the structure of the antenna element. Moreover, a direct-current signal for controlling the switching element is transmitted through the excitation portion of the antenna element. Therefore, the antenna element can achieve multi-band operation so as to facilitate the miniaturization of the mobile communication device.

In order to make the aforementioned features and advantages of the disclosure more comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a mobile communication device according to an embodiment of the invention.

FIG. 2 is a schematic diagram of an antenna element in operation according to an embodiment of the invention.

FIG. 3 is a schematic diagram of an antenna element in operation according to another embodiment of the invention.

FIG. 4 is a schematic diagram of a mobile communication device according to another embodiment of the invention.

FIG. 5 is a schematic plan diagram of an antenna element and a switching element of FIG. 4.

FIG. 6 is a diagram of return loss of an antenna element according to an embodiment of the invention.

FIG. 7 is a diagram of radiation efficiency of an antenna element according to an embodiment of the invention.

### DESCRIPTION OF THE EMBODIMENTS

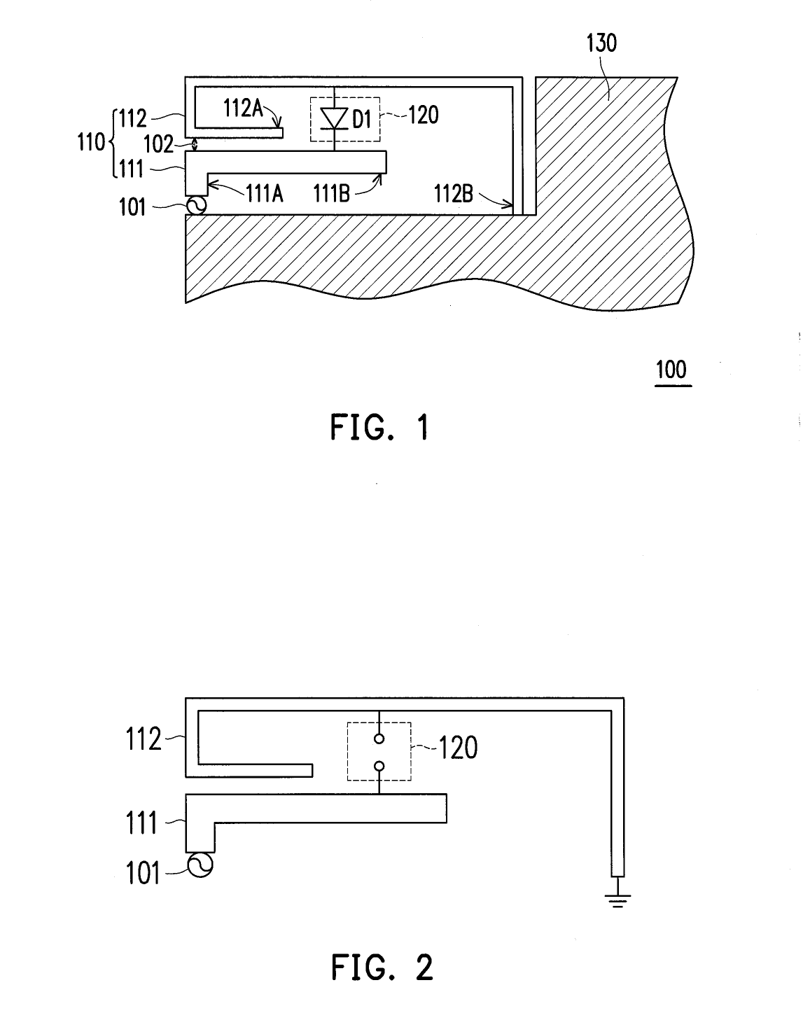

FIG. 1 is a schematic diagram of a mobile communication device according to an embodiment of the invention. As shown in FIG. 1, a mobile communication device 100 includes an antenna element 110 and a switching element 120 and the antenna element 110 includes an excitation portion 111 and a shorting portion 112. The excitation portion 111 and the shorting portion 112 are spaced by a coupling gap 102. The shorting portion 112 is electrically connected to a ground element 130. The switching element 120 is electrically connected between the excitation portion 111 and the shorting portion 112.

In operation, the excitation portion 111 receives a radio-frequency signal and a direct-current signal provided by a signal source 101. The switching element 120 switches the structure of the antenna element 110 according to the direct-current signal. Accordingly, the antenna element 110 can use different structures to convert the radio-frequency signal into an electromagnetic wave. In other words, under the control of the switching element 120, the antenna element 110 is equivalent to a tunable antenna. Therefore, the antenna element 110 has the characteristics of multi-band operation so as to facilitate the miniaturization of the mobile communication device 100. Moreover, the direct-current signal for controlling the switching element 120 is transmitted through the excitation portion 111. Therefore, the design complexity of a control circuit of the switching element 120 can be simplified so as to further facilitate the miniaturization of the mobile communication device 100.

Furthermore, a first end 111A of the excitation portion 111 is configured to receive the radio-frequency signal and the direct-current signal provided by the signal source 101, and a second end 111B of the excitation portion 111 is an open end. A first end 112A of the shorting portion 112 is an open end, and a second end 112B of the shorting portion 112 is electrically connected to the ground element 130. Moreover, the shorting portion 112 includes at least one bend. Accordingly, the shorting portion 112 can form a plurality of conductive sections connected in series with one another through the at least one bend to reduce the hardware space occupied by the antenna element 110. One of the plurality of conductive sections and the excitation portion 111 are spaced by the coupling gap 102.

It should be mentioned that, the switching element 120 can, for instance, include a diode D1. The diode D1 is electrically connected between the excitation portion 111 and the shorting portion 112. Moreover, the diode D1 is forward or reverse biased in response to a change in the level of the direct-current signal, and is thereby switched to a turned-on state or a turned-off state. Depending on whether the diode D1 is turned on, the switching element 120 can selectively provide a transmission path located between the excitation portion 111 and the shorting portion 112. In other words, the switching element 120 can determine whether or not to provide a transmission path located between the excitation portion 111 and the shorting portion 112 according to the direct-current signal. Moreover, the antenna element 110 has different antenna structures in response to the turned-on or turned-off state of the diode D1.

For instance, FIG. 2 is a schematic diagram of an antenna element in operation according to an embodiment of the invention. As shown in FIG. 2, when the diode D1 is in a reverse bias, the diode D1 is turned off. In this case, the switching element 120 cannot provide the transmission path located between the excitation portion 111 and the shorting portion 112. As a result, the antenna element 110 forms a coupled-fed loop antenna structure. Specifically, the excitation portion 111 generates a resonant mode when excited by the radio-frequency signal such that the antenna element 110 covers a first frequency band. Moreover, the radio-frequency signal from the excitation portion 111 is coupled to the shorting portion 112 through the coupling gap 102. Accordingly, the antenna element 110 can generate another resonant mode to cover a second frequency band. In other words, when the diode D1 is turned off, that is, when the transmission path located between the excitation portion 111 and the shorting portion 112 is not provided, the antenna element 110 forms the coupled-fed loop antenna structure and can operate in the first frequency band and the second frequency band through the coupled-fed loop antenna structure.

FIG. 3 is a schematic diagram of an antenna element in operation according to another embodiment of the invention. As shown in FIG. 3, when the diode D1 is in a forward bias, the diode D1 is turned on. In this case, the switching element 120 can provide the transmission path located between the excitation portion 111 and the shorting portion 112. As a result, the antenna element 110 forms an inverted-F antenna structure. Specifically, the antenna element 110 generates a resonant mode when excited by the radio-frequency signal to cover a third frequency band. In other words, when the diode D1 is turned on, that is, when the transmission path located between the excitation portion 111 and the shorting portion 112 is provided, the antenna element 110 forms the inverted-F antenna structure and the antenna element 110 can operate in the third frequency band through the inverted-F antenna structure.

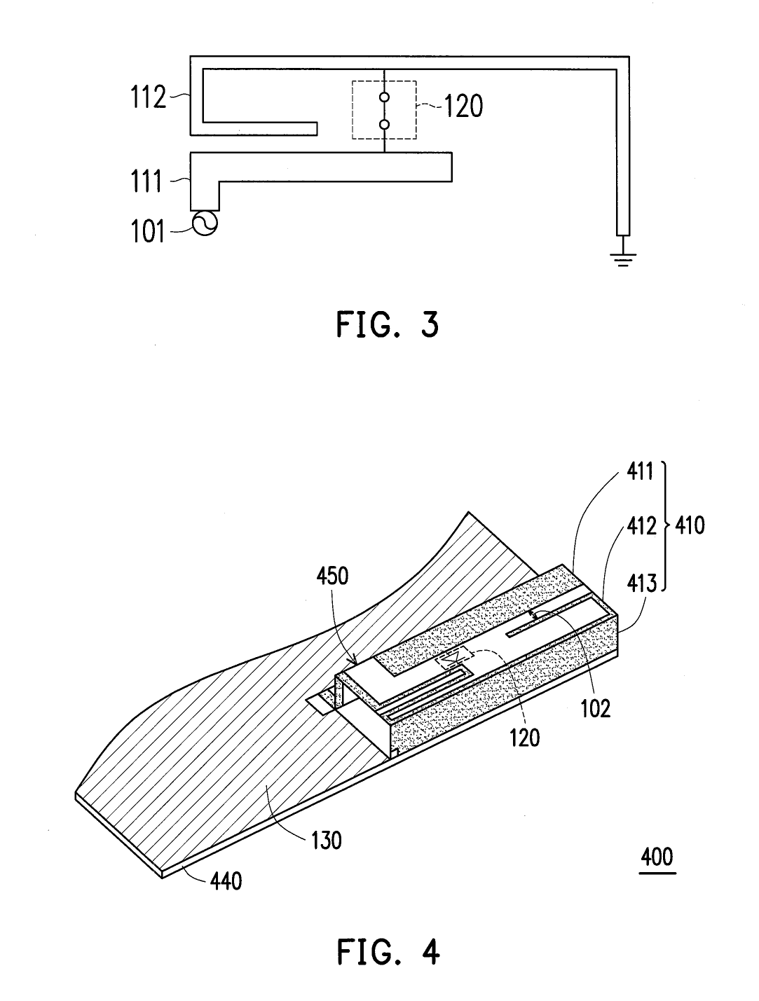

FIG. 4 is a schematic diagram of a mobile communication device according to another embodiment of the invention. A mobile communication device 400 illustrated in FIG. 4 is basically similar to the mobile communication device 100 illustrated in FIG. 1. The main difference between the embodiments of FIG. 4 and FIG. 1 is, the mobile communication device 400 in FIG. 4 further includes a substrate 440 and a carrying element 450, and the antenna element 410 further includes a matching conductive sheet 413.

Specifically, the carrying element 450 and the ground element 130 are disposed on a surface of the substrate 440. The excitation portion 411, the shorting portion 412, and the switching element 120 are disposed on the first surface of the carrying element 450. Moreover, the excitation portion 411 and the shorting portion 412 are extended from the first surface to the second surface of the carrying element 450 such that a first end 411A of the excitation portion 411 and a second end 412B of the shorting portion 412 are adjacent to the ground element 130. Moreover, the matching conductive sheet 413 is disposed on the third surface of the carrying element 450.

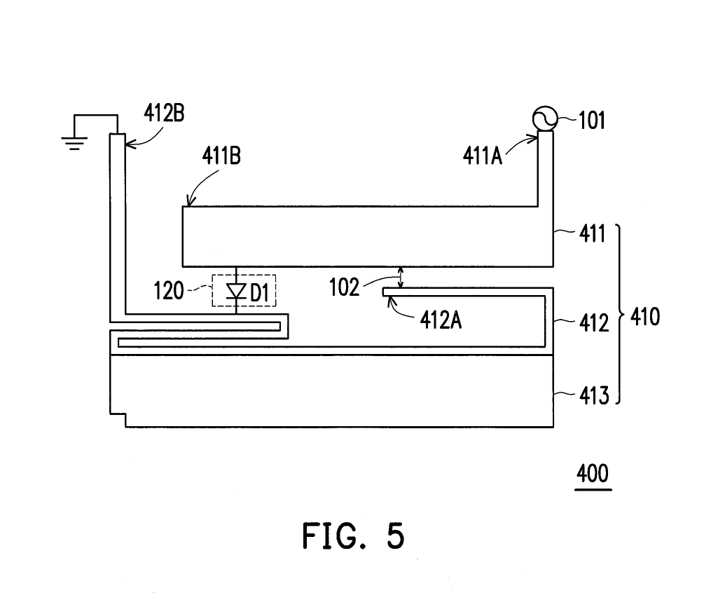

FIG. 5 is a schematic plan diagram of an antenna element and a switching element of FIG. 4. As shown in FIG. 5, the matching conductive sheet 413 is electrically connected to the shorting portion 412. Accordingly, the matching conductive sheet 413 can improve the impedance matching of the antenna element 410, thereby increasing the radiation efficiency of the antenna element 410 in a low-frequency band. Moreover, the width of the first end 411A of the excitation portion 411 is less than the width of a second end 411B thereof. A first end 412A of the shorting portion 412 is an open end, and a second end 412B of the shorting portion 412 is electrically connected to the ground element 130. Moreover, the shorting portion 412 includes a plurality of bends to form a plurality of conductive sections connected in series with one another. One of the plurality of conductive sections and the excitation portion 411 are spaced by the coupling gap 102, and another conductive section of the plurality of conductive sections is electrically connected to the shorting portion 412.

Similarly to the embodiment of FIG. 1, the first end 411A of the excitation portion 411 is configured to receive the radio-frequency signal and the direct-current signal provided by the signal source 101. Moreover, the switching element 120 controls the diode D1 according to the direct-current signal to determine whether or not to provide a transmission path located between the excitation portion 411 and the shorting portion 412. Accordingly, when the diode D1 is turned off, that is, when the transmission path located between the excitation portion 411 and the shorting portion 412 is not provided, the antenna element 410 forms a coupled-fed loop antenna structure and can operate in the first frequency band and the second frequency band through the coupled-fed loop antenna structure. When the diode D1 is turned on, that is, when the transmission path located between the excitation portion 411 and the shorting portion 412 is provided, the antenna element 410 forms an inverted-F antenna structure and the antenna element 410 can operate in the third frequency band through the inverted-F antenna structure.

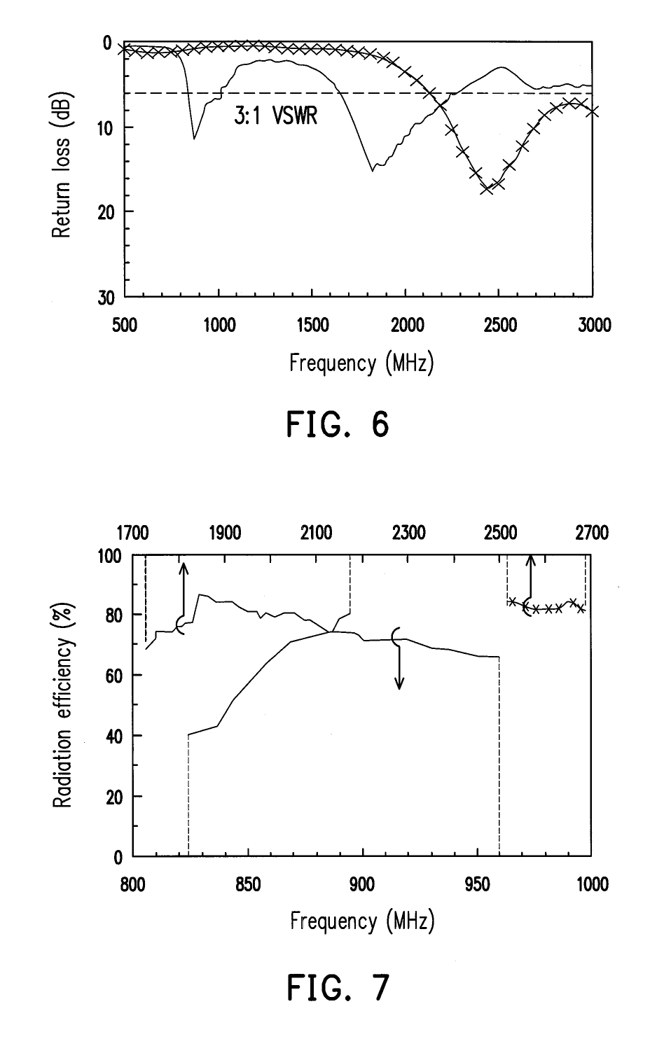

For instance, FIG. 6 is a diagram of return loss of an antenna element according to an embodiment of the invention, and FIG. 7 is a diagram of radiation efficiency of an antenna element according to an embodiment of the invention. In the embodiments of FIG. 6 and FIG. 7, the size of the substrate 440 is about 110×60 mm², which is close to a 4.7-inch smart phone. The size of the carrying element 450 is about 30×10 mm² and the height of the antenna element 410 is about 5 mm. The length of the excitation portion 411 is about 25 mm and the length of the shorting portion 412 is about 87 mm. Moreover, in the embodiment of FIG. 6, the operation bandwidth of the antenna element 410 is defined by a return loss of 6 dB, that is, a voltage standing wave ratio (VSWR) of 3:1.

As shown in FIG. 6, when the antenna element 410 forms the coupled-fed loop antenna structure, the antenna element 410 covers frequency bands such as GSM850/900/1800/1900/WCDMA Band 1. When the antenna element 410 forms the inverted-F antenna structure, the antenna element 410 covers a frequency band such as LTE Band 7. Moreover, as shown in FIG. 7, the radiation efficiency of the antenna element 410 in a low-frequency band (824-960 MHz) of a wireless wide area network (WWAN) is about 40%-72%, and the radiation efficiency of the antenna element 410 in a high-frequency band (1,710-2,170 MHz) of the WWAN is about 68%-84%. Moreover, the radiation efficiency of the antenna element 410 in the LTE Band 7 (2,500-2,690 MHz) is about 81%-85%.

Based on the above, in the invention, a switching element is disposed between an excitation portion and a shorting portion of an antenna element, and the switching element is configured to switch the structure of the antenna element. Accordingly, the antenna element has the characteristics of multi-band operation so as to facilitate the miniaturization of the mobile communication device. Moreover, a direct-current signal for controlling the switching element is transmitted through the excitation portion. Therefore, the design complexity of a control circuit of the switching element can be simplified so as to further facilitate the miniaturization of the mobile communication device.

Although the invention has been described with reference to the above embodiments, it will be apparent to one of the ordinary skill in the art that modifications to the described embodiments may be made without departing from the spirit of the invention. Accordingly, the scope of the invention is defined by the attached claims not by the above detailed descriptions.

What is claimed is:

1. A mobile communication device, comprising:
an antenna element converting a radio-frequency signal into an electromagnetic wave and comprising:
an excitation portion receiving the radio-frequency signal and a direct-current signal; and
a shorting portion electrically connected to a ground element, wherein the shorting portion and the excitation portion are spaced by a coupling gap; and
a switching element electrically connected between the excitation portion and the shorting portion and switching a structure of the antenna element according to the direct-current signal.

2. The mobile communication device of claim 1, wherein the switching element comprises a diode, and the diode is electrically connected between the excitation portion and the shorting portion.

3. The mobile communication device of claim 2, wherein when the diode is turned on according to the direct-current signal, the antenna element forms an inverted-F antenna structure, and when the diode is turned off according to the direct-current signal, the antenna element forms a coupled-fed loop antenna structure.

4. The mobile communication device of claim 3, wherein the antenna element operates in a first frequency band and a second frequency band through the coupled-fed loop antenna structure, and the antenna element operates in a third frequency band through the inverted-F antenna structure.

5. The mobile communication device of claim 1, wherein the switching element determines whether or not to provide a transmission path located between the excitation portion and the shorting portion according to the direct-current signal, when the transmission path is provided, the antenna element forms an inverted-F antenna structure, and when the transmission path is not provided, the antenna element forms a coupled-fed loop antenna structure.

6. The mobile communication device of claim 1, wherein a first end of the excitation portion receives the radio-frequency signal and the direct-current signal, and a second end of the excitation portion is an open end.

7. The mobile communication device of claim 1, wherein a first end of the shorting portion is an open end and a second end of the shorting portion is electrically connected to the ground element.

8. The mobile communication device of claim 1, wherein the shorting portion comprises at least one bend.

9. The mobile communication device of claim 1, wherein the antenna element further comprises:
a matching conductive sheet electrically connected to the shorting portion.

10. The mobile communication device of claim 9, further comprising:
a substrate; and
a carrying element disposed with the ground element on a surface of the substrate, wherein the excitation portion and the shorting portion are disposed on a first surface and a second surface of the carrying element, the matching conductive sheet is disposed on a third surface of the carrying element, and the switching element is disposed on the first surface of the carrying element.
